(19) United States
(12) Patent Application Publication
(10) Pub. No.: US 2018/0277851 A1
(43) Pub. Date: Sep. 27, 2018

(54) LITHIUM SECONDARY BATTERY

(71) Applicant: Samsung SDI Co., Ltd., Yongin-si (KR)

(72) Inventors: Hogon YOU, Yongin-si (KR); Inho JUNG, Yongin-si (KR)

(21) Appl. No.: 15/927,903

(22) Filed: Mar. 21, 2018

(30) Foreign Application Priority Data
Mar. 22, 2017 (KR) 10-2017-0036189

(51) Int. Cl. H01M 4/62; H01M 10/052; H01M 4/587; H01M 10/0567; H01M 4/36

(52) U.S. Cl. CPC H01M 4/628; H01M 10/052; H01M 4/587; H01M 2004/027; H01M 4/366; H01M 2300/0025; H01M 10/0567

(57) ABSTRACT

Provided is a lithium secondary battery including a positive electrode, a negative electrode, and an electrolyte interposed between the positive electrode and the negative electrode, wherein a passivation layer is on at least one portion of a surface of the negative electrode after one or more cycles of charging and discharging of the lithium secondary battery, and the passivation layer includes a particulate passivation layer and a film-like passivation layer.

### CROSS-REFERENCE TO RELATED APPLICATION

This application claims priority to and the benefit of Korean Patent Application No. 10-2017-0036189, filed on Mar. 22, 2017, in the Korean Intellectual Property Office, the entire content of which is incorporated herein by reference.

### BACKGROUND

### 1. Field

One or more embodiments relate to lithium secondary batteries including a passivation layer on (e.g., formed on) a surface of a negative electrode.

### 2. Description of the Related Art

A lithium secondary battery generally includes a positive electrode, a negative electrode, and an electrolyte. When the electrolyte is brought into contact with active materials of the electrodes, oxidation and reduction reactions of components of the electrolyte occur. Although some products of these reactions are desorbed or eluted therefrom, others are deposited on the surface of the electrode to form a passivation layer on the surface of an active material.

Since the behavior of the passivation layer is similar to that of a solid electrolyte, due to a very low electronic conductivity and a very high lithium ion conductivity, the passivation layer is also referred to as a solid electrolyte interphase (SEI) layer.

### SUMMARY

One or more embodiments include a lithium secondary battery having a high initial efficiency and a high capacity during charging and discharging.

One or more embodiments include a lithium secondary battery having a high capacity and a long lifespan by suppressing or reducing a thickness increase of the battery during charging and discharging.

Embodiments of a lithium secondary battery include: a positive electrode; a negative electrode; and an electrolyte interposed between the positive electrode and the negative electrode, where a passivation layer is on (e.g., formed on) at least one portion of a surface of the negative electrode after one or more cycles of charging and discharging of the lithium secondary battery, and where the passivation layer comprises a particulate passivation layer and a film-like passivation layer.

### BRIEF DESCRIPTION OF THE DRAWINGS

These and/or other aspects will become apparent and more readily appreciated from the following description of the embodiments, taken in conjunction with the accompanying drawings in which:

FIG. 1 is a scanning electron microscope (SEM) image of a passivation layer of a lithium secondary battery according to an embodiment;

FIGS. 2A-2D are SEM images of a passivation layer of a lithium secondary battery according to an embodiment;

FIGS. 3A-3C are SEM images of a passivation layer of a comparative lithium secondary battery;

FIGS. 4A-4B are graphs illustrating analysis results of surface compositions and thicknesses of a film-like passivation layer of a lithium secondary battery according to an embodiment after one cycle of charging and discharging and after 300 cycles of charging and discharging analyzed by field emission Auger electron spectroscopy (FE-AES) respectively;

FIGS. 5A-5B are graphs illustrating FE-AES analysis results of surface compositions and thicknesses of a film-like passivation layer of a comparative lithium secondary battery after one cycle of charging and discharging and after 300 cycles of charging and discharging respectively;

FIG. 6 is a graph illustrating thickness increase rates of a lithium secondary battery according to an embodiment and of a comparative lithium secondary battery with respect to the number of cycles;

FIG. 7 is a graph illustrating capacity variations of a lithium secondary battery according to an embodiment and a comparative lithium secondary battery with respect to the number of cycles; and

FIG. 8 is a diagram schematically illustrating a structure of a lithium secondary battery according to an embodiment.

### DETAILED DESCRIPTION

Reference will now be made in more detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

A lithium secondary battery according to exemplary embodiments will be described in more detail with reference to the accompanying drawings.

A lithium secondary battery according to an embodiment includes a positive electrode, a negative electrode, and an electrolyte interposed between the positive electrode and the negative electrode, wherein a passivation layer is on (e.g., formed on) at least one portion of a surface of the negative electrode after one or more cycles of charging and discharging of the lithium secondary battery and the passivation layer includes a particulate passivation layer and a film-like passivation layer.

The lithium secondary battery according to the embodiment may have excellent lifespan characteristics and high capacity by suppressing or reducing thickness changes in cells.

According to an exemplary embodiment, a thickness of the film-like passivation layer may be 10 nm or greater. According to another exemplary embodiment, the thickness of the film-like passivation layer may be 15 nm or greater, for example, 20 nm or greater, without being limited thereto. For example, the thickness of the film-like passivation layer may be in a range from about 10 nm to about 300 nm, for example in a range from about 15 nm to about 150 nm, or in a range from about 20 nm to about 80 nm, without being limited thereto.

According to an exemplary embodiment, a thickness D₁ of the film-like passivation layer may be 10 nm or greater, for example, 15 nm or greater, or 20 nm or greater after one cycle of charging and discharging of the lithium secondary battery, without being limited thereto. For example, the thickness D₁ of the film-like passivation layer may be in a range from about 10 nm to about 300 nm, for example in a range from about 15 nm to about 150 nm, or in a range from about 20 nm to about 80 nm after one cycle of charging and discharging of the lithium secondary battery, without being limited thereto.

According to an exemplary embodiment, a ratio D₃₀₀/D₁ of a thickness D₃₀₀ of the film-like passivation layer after 300 cycles of charging and discharging of the lithium secondary battery to a thickness D₁ of the film-like passivation layer after one cycle of charging and discharging of the lithium secondary battery is in a range from about 1.0 to about 1.5, for example in a range from about 1.0 to about 1.15, or in a range from about 1.01 to about 1.1. For example, the lithium secondary battery may have long lifespan and high capacity due to small thickness changes in the passivation layer.

According to an exemplary embodiment, the thickness of the particulate passivation layer may be in a range from about 100 to about 600 nm, for example in a range from about 100 to about 400 nm.

According to another exemplary embodiment, the particulate passivation layer has a three-dimensional structure or a shape in which a plurality of spherical particles aggregate.

According to an exemplary embodiment, the particulate passivation layer may include spherical particles having an average diameter in a range of about 50 nm to about 500 nm, for example, about 100 nm to about 200 nm. When the average diameter of the particles of the particulate passivation layer satisfies the ranges described above, the lithium secondary battery may have excellent lifespan and capacity characteristics since a resistance increase in the battery is inhibited in comparison with a lithium secondary battery including a particulate passivation layer densely formed of smaller particles with a smaller average diameter and the lithium secondary battery may also have less of a thickness increase (e.g., a reduced thickness increase) in initial cells in comparison with a lithium secondary battery including a particulate passivation layer formed of larger particles with a larger average diameter.

According to an exemplary embodiment, a ratio of the thickness of the particulate passivation layer to the thickness of the film-like passivation layer may be in a range from about 20:1 to about 3:1, for example in a range from about 15:1 to about 5:1. When the ratio of the thickness of the particulate passivation layer to the thickness of the film-like passivation layer of the lithium secondary battery satisfies the ranges described above, the particulate passivation layer is suitably or sufficiently grown, and thus oxidation and reduction reactions between the active material and the electrolyte may be efficiently inhibited.

The above-described thicknesses of the passivation layer are values relatively estimated from sputtering results of Auger Electron Spectroscopy (AES) under discharging conditions of the lithium secondary battery.

According to an exemplary embodiment, the passivation layer may include an organic compound, an inorganic compound, or any combination thereof. For example, the passivation layer may include but is not limited to: a hydrocarbon compound; an inorganic compound such as LiF and LiPF₆ and a reduced form thereof; or an organic compound comprising C—O, C═O, or any combination thereof.

According to an exemplary embodiment, the particulate passivation layer may include an inorganic compound. For example, the particulate passivation layer may include an inorganic compound including a fluorine atom, without being limited thereto.

According to an exemplary embodiment, the particulate passivation layer may include an inorganic compound such as LiF and LiPF₆ and a reduced form thereof, without being limited thereto.

According to an exemplary embodiment, the film-like passivation layer may be formed of an organic compound.

According to an exemplary embodiment, the passivation layer may be on (e.g., formed on) at least 40% by area, at least 55% by area, for example at least 65% by area, or at least 80% by area of the surface of the negative electrode.

According to another exemplary embodiment, the film-like passivation layer may be on (e.g., formed on) at least 35% by area, for example at least 50% by area, or at least 65% by area of the surface of the negative electrode.

When the area of the passivation layer satisfies the ranges described above, oxidation and reduction reactions of the electrolyte do not proceed (or substantially do not proceed) further and resistance of the passivation layer is maintained under a set or given level, and thus the lithium secondary battery may have excellent lifespan and capacity characteristics.

According to an exemplary embodiment, a C-rate at which the one cycle of charging and discharging of the lithium secondary battery is performed is in a range from about 0.001 C to about 0.4 C, for example in a range from about 0.01 C to about 0.2 C.

According to another exemplary embodiment, a temperature at which the one cycle of charging and discharging of the lithium secondary battery is performed is in a range from about 25° C. to about 80° C.

In addition, a voltage at which the one cycle of charging and discharging of the lithium secondary battery is performed is in a range from about 2.7 V to about 4.4 V, for example, in a range from about 3.0 V to about 4.3 V, without being limited thereto.

When the above-described conditions for one cycle of charging and discharging of the lithium secondary battery are satisfied, the film-like passivation layer and the particulate passivation layer described above are formed, and thus suitable or sufficient battery capacity and long lifespan may be obtained. According to an exemplary embodiment, since the film-like passivation layer and the particulate passivation layer described above are formed at a low C-rate of about 0.01 C and at a high temperature of about 60° C. among the initial charging and discharging conditions of the lithium secondary battery, high battery capacity and long lifespan may be obtained.

The negative electrode according to an exemplary embodiment includes a negative current collector, and a negative active material layer on (e.g., formed on) the negative current collector, wherein the passivation layer is on (e.g., formed on) the negative active material layer. Materials used to form the negative current collector and the negative active material layer may be any suitable materials selected with reference to manufacturing methods of lithium secondary batteries generally used in the art and materials generally used to form lithium secondary batteries which will be described later without limitation. For example, the negative current collector may include copper (Cu).

According to an exemplary embodiment, the negative active material layer may include a carbonaceous negative active material. For example, the negative active material layer may include graphite.

According to an exemplary embodiment, the electrolyte may include a lithium salt, a non-aqueous organic solvent, and an additive.

According to an exemplary embodiment, the additive may include vinylene carbonate (VC), vinyl ethylene carbonate (VEC), fluoroethylene carbonate, and the like, without being limited thereto.

Hereinafter, a general method of manufacturing a lithium secondary battery according to an embodiment and materials used to manufacture the lithium secondary battery will be exemplarily described. However, examples of the manufacturing method and materials used to form the lithium secondary battery are not limited thereto and any suitable methods and materials available in the art may also be applied thereto.

For example, the lithium secondary battery may be manufactured according to the following method.

First, a positive electrode is prepared.

For example, a positive active material composition in which a positive active material, a conductive material, a binder, and a solvent are mixed is prepared. The positive active material composition is directly coated on a metal current collector to manufacture a positive electrode plate. Alternatively, or additionally, the positive active material composition is cast on a separate support and a film separated from the support is laminated on a metal current collector to manufacture a positive electrode plate. However, the positive electrode is not limited to the examples described above and may have various shapes.

The positive active material may include a lithium-containing metal oxide and may further include any suitable material generally used in the art without limitation. For example, a composite oxide of lithium and a metal selected from cobalt (Co), manganese (Mn), nickel (Ni), and any combination thereof may be used. For example, a compound represented by any one of the following formulae LiₐA_{1-b}B¹_{b}D¹₂ (where 0.90≤a≤1.8 and 0≤b≤0.5); LiₐE_{1-b}B¹_{b}O_{2-c}D¹_{c} (where 0.90≤a≤1.8, 0≤b≤0.5, and 0≤c≤0.05); LiE_{2-b}B¹_{b}O_{4-c}D¹_{c} (where 0≤b≤0.5 and 0≤c≤0.05); LiₐNi_{1-b-c}Co_{b}B¹_{c}D¹_{α} (where 0.90≤a≤1.8, 0≤b≤0.5, 0≤c≤0.05, and 0<α≤2); LiₐNi_{1-b-c}Co_{b}B¹_{c}O_{2-α}F¹_{α} (where 0.90≤a≤1.8, 0≤b≤0.5, 0≤c≤0.05, and 0<α<2); LiₐNi_{1-b-c}Co_{b}B¹_{c}O_{2-α}F¹₂ (where 0.90≤a≤1.8, 0≤b≤0.5, 0≤c≤0.05, and 0<α<2); LiₐNi_{1-b-c}Mn_{b}B¹_{c}D¹_{α} (where 0.90≤a≤1.8, 0≤b≤0.5, 0≤c≤0.05, and 0≤a≤2); LiₐNi_{1-b-c}Mn_{b}B¹_{c}O_{2-α}F¹_{α} (where 0.90≤a≤1.8, 0≤b≤0.5, 0≤c≤0.05, and 0<α<2); LiₐNi_{1-b-c}Mn_{b}B¹_{c}O_{2-α}F¹₂ (where 0.90≤a≤1.8, 0≤b≤0.5, 0≤c≤0.05, and 0<α<2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂GbO₄ (where 0.90≤a≤1.8 and 0.001≤b≤0.1); QO₂; QS₂; LiQS₂; V₂O₅; LiV₂O₅; LiI¹O₂; LiNiVO₄; Li_{(3-f)}J₂(PO₄)₃ (0≤f≤2); Li_{(3-f)}Fe₂(PO₄)₃ (0≤f≤2); and LiFePO₄ may be used.

In the formulae, A is Ni, Co, Mn, or any combination thereof; B or B¹ is Al, Ni, Co, Mn, Cr, Fe, Mg, Sr, V, a rare earth element, or any combination thereof; D or D¹ is O, F, S, P, or any combination thereof; E is Co, Mn, or any combination thereof; F or F¹ is F, S, P, or any combination thereof; G is Al, Cr, Mn, Fe, Mg, La, Ce, Sr, V, or any combination thereof; Q is Ti, Mo, Mn, or any combination thereof; I or I¹ is Cr, V, Fe, Sc, Y, or any combination thereof; and J is V, Cr, Mn, Co, Ni, Cu, or any combination thereof.

For example, LiCoO₂, LiMnₓO₂ₓ (x=1, 2), LiNi₁₋ₓMnₓO₂ₓ (0<x<1), LiNi_{1-x-y}CoₓMn_{y}O₂ (0≤x≤0.5 and 0≤y≤0.5), LiFePO₄, and the like may be used.

The compounds listed above may have a coating layer on the surface thereof or a mixture of a compound with no coating layer and a compound having a coating layer may also be used. The coating layer may include a compound of a coating element, such as an oxide, hydroxide, oxyhydroxide, oxycarbonate, or hydroxycarbonate of the coating element. The compound constituting the coating layer may be amorphous or crystalline. Examples of the coating element contained in the coating layer may be Mg, Al, Co, K, Na, Ca, Si, Ti, V, Sn, Ge, Ga, B, As, Zr, or a mixture thereof. The coating layer may be on (e.g., formed on) the compound by using the coating element by any coating method, which does not adversely affect physical properties of the positive active material (e.g., spray coating and immersing). These methods will be apparent to those of ordinary skill in the art upon reviewing the present disclosure, and thus detailed descriptions thereof are not necessary here.

The conductive material may be, but not limited to, carbon black, graphite particulates, or the like and any suitable material generally used in the art as a conductive material may also be used.

The binder may be a vinylidene fluoride/hexafluoropropylene copolymer, polyvinylidene fluoride (PVdF), polyacrylonitrile, polymethylmethacrylate, polytetrafluoroethylene and any mixture thereof, a styrene butadiene rubber polymer, or the like. However, the binder is not limited thereto and any suitable material generally used in the art as a binder may also be used.

The solvent may be N-methyl pyrrolidone, acetone, water, or the like. However, the solvent is not limited thereto and any suitable material generally used in the art as a solvent may also be used.

The positive active material, the conductive material, the binder, and the solvent may be used in amounts generally used in lithium batteries. At least one of the conductive material, the binder, and the solvent may not be used according to use and configuration of the lithium secondary battery.

Next, a negative electrode is prepared.

For example, a negative active material, a conductive material, a binder, and a solvent are mixed to prepare a negative active material composition. The negative active material composition is directly coated on a metal current collector and dried to manufacture a negative electrode plate. Alternatively, or additionally, the negative active material composition is cast on a separate support and a film separated from the support is laminated on a metal current collector to manufacture a negative electrode plate.

The negative active material may be any suitable material generally used as a negative active material in lithium secondary batteries. For example, the negative active material may include at least one selected from lithium metal, a metal that is alloyable with lithium, a transition metal oxide, a non-transition metal oxide, and a carbonaceous material.

For example, the metal alloyable with lithium may be Si, Sn, Al, Ge, Pb, Bi, Sb, an Si—Y alloy (where Y is alkali metal, alkali earth metal, Group XIII element, Group XIV element, transition metal, rare earth element, or a combination thereof (except for Si)), an Sn—Y alloy (where Y is alkali metal, alkali earth metal, Group XIII element, Group XIV element, transition metal, rare earth element, or a combination thereof (except for Sn)), or the like. The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, or Te.

For example, the transition metal oxide may be lithium titanium oxide, vanadium oxide, lithium vanadium oxide, or the like.

For example, the non-transition metal oxide may be SnO₂, SiOₓ (0<x<2), or the like.

The carbonaceous material may be crystalline carbon, amorphous carbon, or any mixture thereof. The crystalline carbon may be natural graphite or artificial graphite in amorphous, plate, flake, spherical or fibrous form. The amorphous carbon may be soft carbon (carbon sintered at low temperatures), hard carbon, meso-phase pitch carbides, sintered coke, or the like.

The conductive material, the binder, and the solvent used in the negative active material composition may be the same or substantially the same as those used in the positive active material composition.

The amounts of the negative active material, the conductive material, the binder, and the solvent are amounts generally used in the art in the manufacture of lithium batteries. At least one of the conductive material, the binder, and the solvent may not be used according to use and configuration of the lithium secondary battery.

Next, a separator to be interposed between the positive electrode and the negative electrode is prepared.

The separator may be any separator generally used in lithium batteries. A separator that has low resistance to migration of ions of an electrolyte and excellent electrolytic solution-retaining ability may be used. For example, the separator may be glass fiber, polyester, Teflon, polyethylene, polypropylene, polytetrafluoroethylene (PTFE), or a combination thereof, each of which may be a nonwoven fabric or a woven fabric. For example, a windable separator such as polyethylene or polypropylene may be used in lithium-ion batteries. A separator having an excellent organic electrolyte retaining capability may be used in lithium-ion polymer batteries. For example, the separator may be prepared according to the following method.

A polymer resin, a filler, and a solvent are mixed to prepare a separator composition. The separator composition may be directly coated on the electrode and dried to form a separator. Alternatively, or additionally, the separator composition may be cast on a support and dried and a separator film separated from the support may be laminated on the electrode to form a separator.

The polymer resin used to manufacture the separator is not particularly limited and may be any suitable material generally used as a binder for electrode plates. For example, the polymer resin may be a vinylidenefluoride/hexafluoropropylene copolymer, polyvinylidene fluoride (PVdF), polyacrylonitrile, polymethylmethacrylate and any mixture thereof.

Next, an electrolyte is prepared.

For example, the electrolyte may be an organic electrolytic solution. Also, the electrolyte may be a solid. For example, the electrolyte may be boron oxide or lithium oxynitride. However, the electrolyte is not limited thereto and any suitable material generally used in the art as a solid electrolyte may also be used. The solid electrolyte may be on (e.g., formed on) the negative electrode by sputtering, or the like.

For example, the organic electrolytic solution may be prepared by dissolving a lithium salt in an organic solvent.

The organic solvent may be any suitable organic solvent generally used in the art. For example, the organic solvent may be propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethyl formamide, dimethyl acetamide, dimethylsulfoxide, dioxane, 1,2-dimethoxyethane, sulfolane, dichloroethane, chlorobenzene, nitrobenzene, diethylene glycol, dimethyl ether, or any mixture thereof.

The lithium salt may be any suitable lithium salt generally used in the art. For example, the lithium salt may be LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural number), LiCl, LiI, or any mixture thereof.

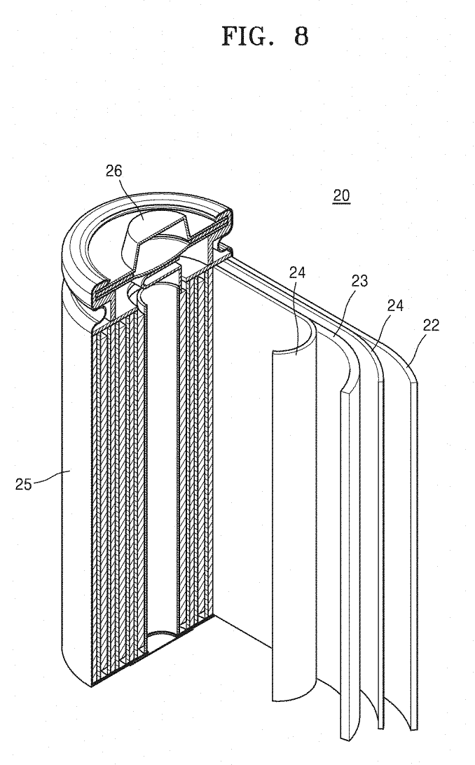

As illustrated in FIG. 8, a lithium secondary battery 20 includes a positive electrode 23, a negative electrode 22, and a separator 24. The positive electrode 23, the negative electrode 22, and the separator 24 are wound up or folded and accommodated in a battery case 25. Next, an organic electrolytic solution is injected into the battery case 25 and the battery case 25 is sealed with a cap assembly 26 to complete the manufacture of the lithium secondary battery 20.

The battery case 25 may be a cylindrical type (or kind), a rectangular type (or kind), a thin-film type (or kind), or the like. For example, the lithium secondary battery 20 may be a thin-film type (or kind) of battery.

The lithium secondary battery 20 may be a lithium ion battery.

A battery assembly may be prepared by interposing the separator between the positive electrode and the negative electrode. When the battery assembly is stacked in a bi-cell structure and impregnated with the organic electrolytic solution, and then the resultant is accommodated in a pouch and sealed, a lithium ion polymer battery is manufactured.

Also, a battery pack may be manufactured by stacking a plurality of battery assemblies and may be used in various devices that require high capacity and high output, such as in laptop computers, smartphones, and electric vehicles.

In addition, the lithium secondary battery may be suitable for electric vehicles (EVs) due to excellent lifespan characteristics and rate-characteristics. For example, the lithium secondary battery may be applied to hybrid electric vehicles such as plug-in hybrid electric vehicles (PHEVs). The lithium secondary battery may also be used in the any device that stores a large amount of power, such as electric bicycles and electric tools.

One or more embodiments will be described in more detail with reference to the following examples and comparative examples. However, these examples and comparative examples are not intended to limit the scope of the one or more embodiments.

### Example 1: Preparation of Lithium Secondary Battery According to an Embodiment

A positive active material slurry was prepared by mixing LiCoO₂ as a positive active material, polyvinylidene fluoride (PVdF) as a binder, and carbon black as a conductive material in N-methyl pyrrolidone as a solvent to a weight ratio of 97.7:1.0: 1.3, respectively. The positive active material slurry was coated on an Al current collector, dried, and rolled to prepare a positive electrode.

A negative active material slurry was prepared by mixing graphite as a negative active material and a styrene butadiene rubber (SBR) as a binder to a weight ratio of 97.7:2.3, respectively, and water dispersing the mixture. The negative active material slurry was coated on a Cu current collector, dried, and rolled to prepare a negative electrode.

An electrolytic solution was prepared by dissolving LiPF₆ as a lithium salt in a mixed solvent of ethylene carbonate, ethylmethyl carbonate, and dimethyl carbonate mixed to a volume ratio of 30:40:20, respectively, to a concentration of 1.15 M.

A lithium secondary battery was prepared according to a process available in the art by using the positive electrode, the negative electrode, the electrolytic solution, and polyethylene (PE) coated with polyvinylidene fluoride (PVdF) as a separator.

The lithium secondary battery was charged/discharged at 45° C. with constant current (CC)-constant voltage (CV) of 0.05 C and 3.4 V to a cut-off current of 0.035 C and discharged with a CC of 0.2 C to a cut-off voltage of 3.9 V for precharging.

### Comparative Example 1: Preparation of Comparative Lithium Secondary Battery

The lithium secondary battery prepared according to Example 1 was charged/discharged at 23° C. with a CC of 0.5 C to a cut-off voltage of 3.9 V for precharging.

### Evaluation Example 1: Observation of Shape of Passivation Layer

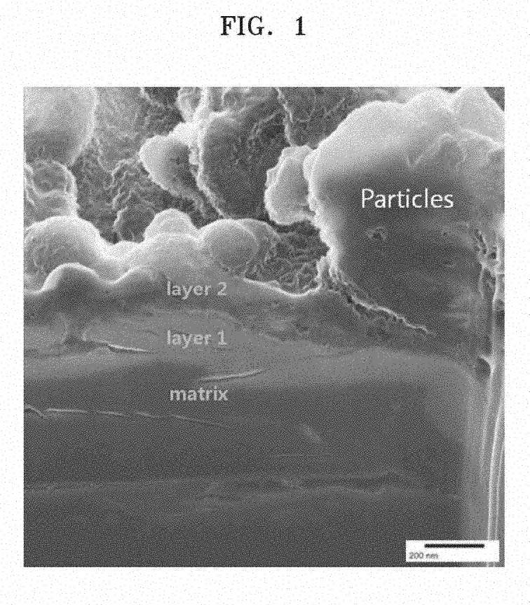

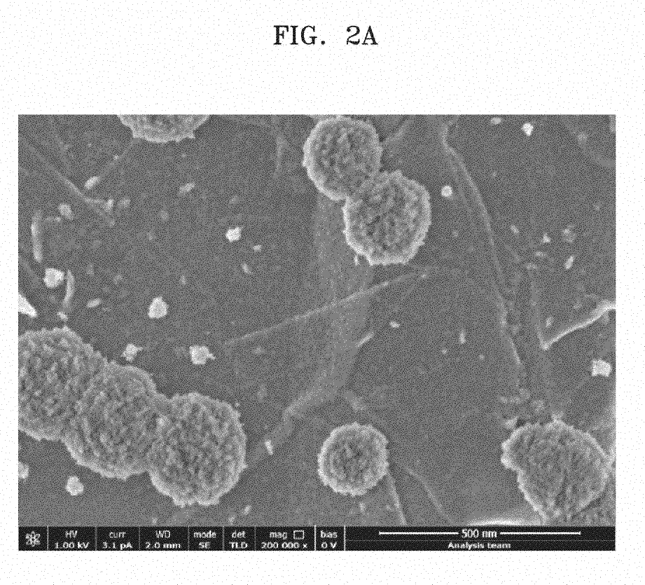

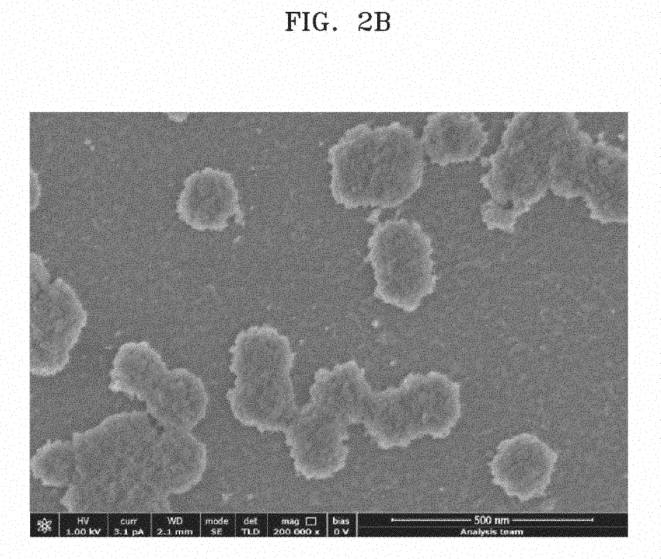

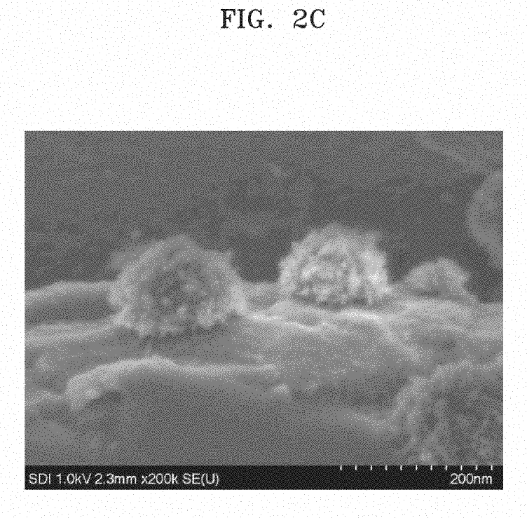

The surface of the negative electrode of the lithium secondary battery prepared according to Example 1 was observed using a scanning electron microscope (SEM) and results are shown in FIGS. 1 and 2A-2D. FIG. 1 shows that the negative electrode included a passivation layer, which includes film-like passivation layer (layer 1 and 2), particulate passivation layer (particles), and a matrix.

Referring to FIGS. 2A-2B, it was confirmed that both a particulate passivation layer formed of particles having a diameter in a range of about 100 to about 200 nm and a film-like passivation layer clearly distinguished therefrom are on (e.g., formed on) the surface of the negative electrode of the lithium secondary battery according to an embodiment.

Also, referring to FIGS. 2C-2D, it was confirmed that the particulate passivation layer is formed of three-dimensional, spherical particles on the surface of the negative electrode and the other portion of the surface of the negative electrode is covered with the film-like passivation layer as a result of observation of the surface of the negative electrode of the lithium secondary battery according to an embodiment from the side.

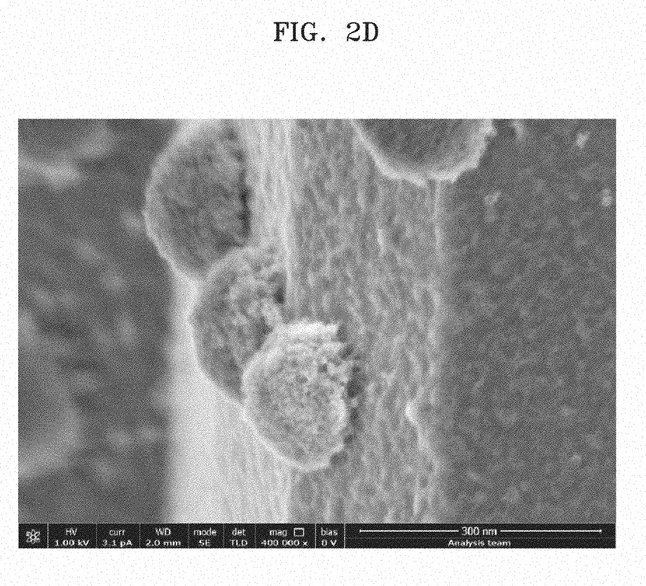

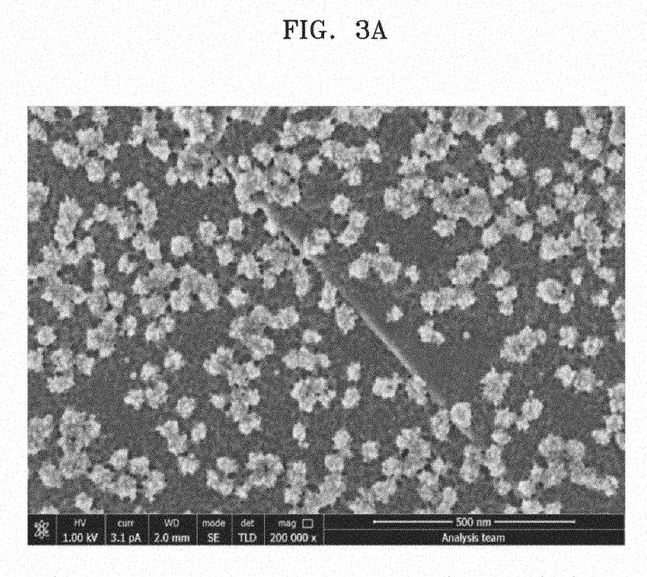

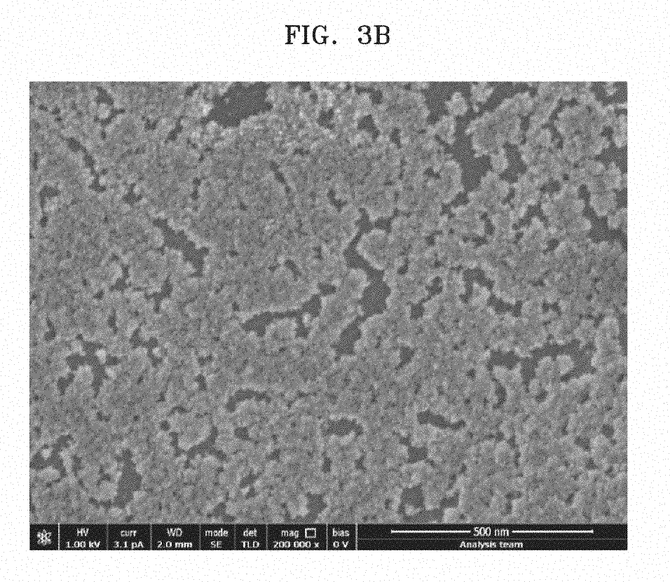

On the contrary, referring to FIGS. 3A-3C, it was confirmed that the comparative lithium secondary battery includes a particulate passivation layer formed of particles having a diameter in a range of about 25 to about 30 nm in an aggregated form rather than exact spherical shapes and a continuous film-like passivation layer is not distinguished from the aggregated form.

### Evaluation Example 2: Measurement of Thickness of Film-Like Passivation Layer

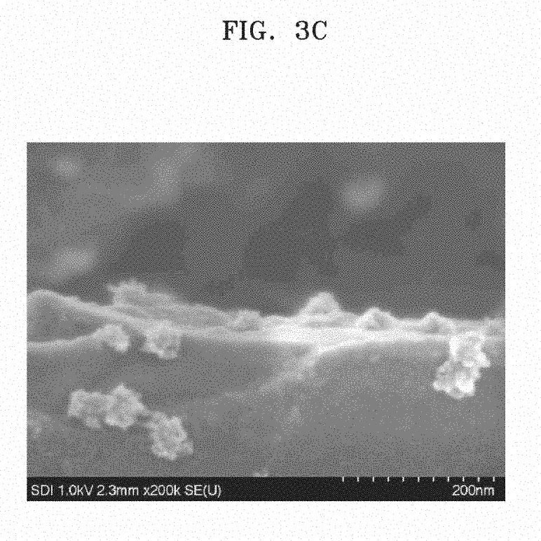

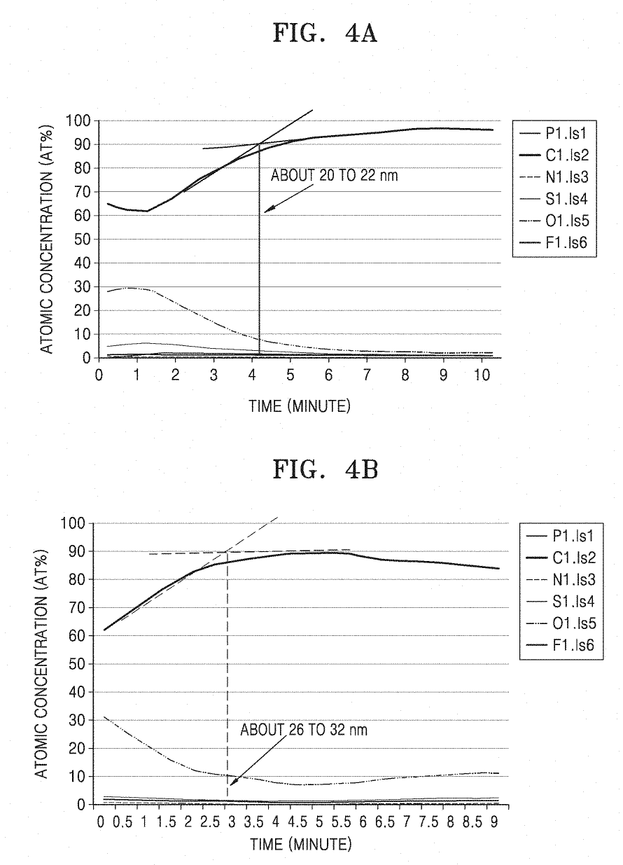

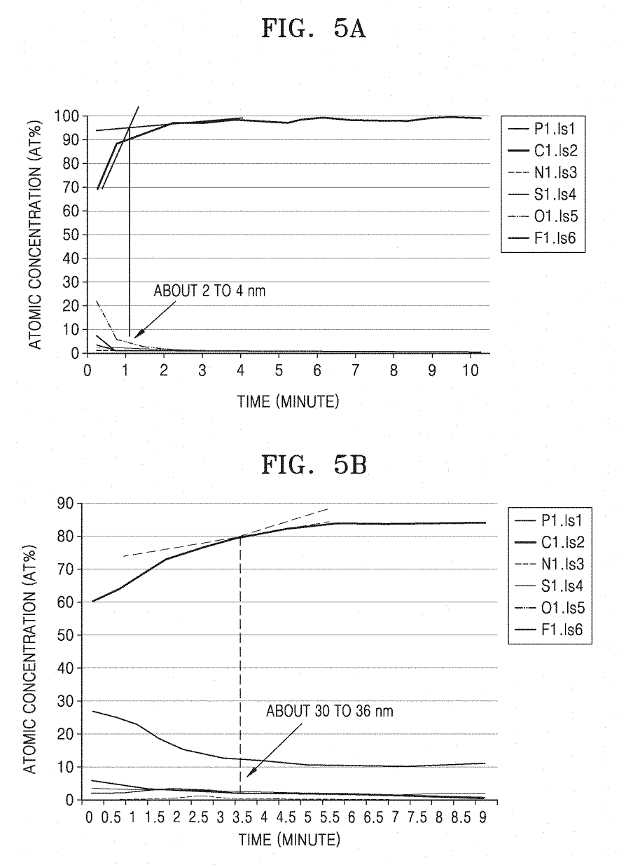

Surface compositions and thicknesses of the film-like passivation layer of the lithium secondary battery prepared according to Example 1 were analyzed by field emission Auger electron spectroscopy (FE-AES) after one cycle of charging and discharging and after 300 cycles of charging and discharging and results are shown in Table 1 below and FIGS. 4A-4B, respectively. In addition, surface compositions and thicknesses of the film-like passivation layer of the comparative lithium secondary battery prepared according to Comparative Example 1 were analyzed by FE-AES after one cycle of charging and discharging and after 300 cycles of charging and discharging and results are shown in Table 2 below and FIGS. 5A-5B, respectively. As used herein, the unit “at %” refers to an atomic percent which is a unit of atomic concentration.

Particularly, the FE-AES was performed in the following manner.

(1) Discharge and disassemble a cell to be analyzed in a moisture-reduced atmosphere (dry room or glove box).

(2) Wash a negative electrode of the cell in the glove box using dimethyl carbonate (DMC) for 10 minutes or more to remove remaining electrolytic solution.

(3) Collect a portion of the surface of the washed negative electrode substrate as a sample.

(4) Mount the sample in an FE-AES device in an air-shielded state and perform sputtering a portion of the film-like passivation layer where no particulate passivation layer is found.

(5) Measure thickness of a portion of the film-like passivation layer where a carbon composition is saturated (about 90% or more) after sputtering and convert the thickness of the passivation layer based on an SiO₂ etching rate.

In Tables 1 and 2 below, Particle 1 and Particle 2 show values respectively measured in particulate passivation layers of the passivation layer on (e.g., formed on) the surface of the negative electrode and Film 1 and Film 2 show values respectively measured in film-like passivation layers of the passivation layer on (e.g., formed on) the surface of the negative electrode. For example, in Table 1, “Particle 1” and “Particle 2” refer to the particulate passivation layer after one cycle of charging and discharging, and “Film 1” and “Film 2” refer to the film-like passivation layer after one cycle of charging and discharging, each with respect to Example 1. Additionally, in Table 2, “Particle 1” and “Particle 2” refer to the particulate passivation layer after one cycle of charging and discharging, and “Film 1” and “Film 2” refer to the film-like passivation layer after one cycle of charging and discharging, each with respect to Comparative Example 1. In FIG. 4A, P1, C1, N1, S1, O1, and F1 refer to the AT % of phosphorus, carbon, nitrogen, sulfur, oxygen, and fluorine, respectively, in the film-like passivation layer of Example 1 after one cycle of charging and discharging. In FIG. 4B, P1, C1, N1, S1, O1, and F1 refer to the AT % of phosphorus, carbon, nitrogen, sulfur, oxygen, and fluorine, respectively, in the film-like passivation layer of Example 1 after 300 cycles of charging and discharging. In FIG. 5A, P1, C1, N1, S1, O1, and F1 refer to the AT % of phosphorus, carbon, nitrogen, sulfur, oxygen, and fluorine, respectively, in the film-like passivation layer of Comparative Example 1 after one cycle of charging and discharging. In FIG. 5B, P1, C1, N1, S1, O1, and F1 refer to the AT % of phosphorus, carbon, nitrogen, sulfur, oxygen, and fluorine, respectively, in the film-like passivation layer of Comparative Example 1 after 300 cycles of charging and discharging.

TABLE 1

| | C (at %) | O (at %) | F (at %) | S (at %) | Total (at %) |
|---|---|---|---|---|---|
| Particle 1 | 65.5 | 24.1 | 5.8 | 4.6 | 100 |
| Particle 2 | 65.0 | 25.9 | 5.0 | 4.1 | 100 |
| Film 1 | 68.7 | 23.3 | 4.4 | 3.6 | 100 |
| Film 2 | 68.8 | 24.6 | 4.4 | 2.2 | 100 |

TABLE 2

| | C (at %) | O (at %) | F (at %) | S (at %) | P (at %) | Total (at %) |
|---|---|---|---|---|---|---|
| Particle 1 | 62.6 | 21.7 | 8.1 | 4.3 | 3.2 | 100 |
| Particle 2 | 63.0 | 21.5 | 7.6 | 4.5 | 3.4 | 100 |
| Film 1 | 67.5 | 23.3 | 6.3 | 3.0 | — | 100 |
| Film 2 | 67.3 | 23.5 | 6.4 | 2.8 | — | 100 |

Referring to the compositions of Table 1 and FIGS. 4A-4B, thicknesses of the film-like passivation layer of the lithium secondary battery of Example 1 were in a range from about 20 to about 22 nm after one cycle of charging and discharging and in a range from about 26 to about 32 nm after 300 cycles of charging and discharging. Thus, it was confirmed that the thickness of the film-like passivation layer was not considerably changed although the number of cycles increased.

On the contrary, referring to the compositions of Table 2 and FIGS. 5A-5B, thicknesses of the passivation layer of the lithium secondary battery of Comparative Example 1 were in a range from about 2 nm to about 4 nm after one cycle of charging and discharging indicating that the passivation layer was hardly formed and in a range from about 30 nm to about 36 nm after 300 cycles of charging and discharging indicating that the thickness of the passivation layer was considerably changed.

### Evaluation Example 3: Measurement of Thickness Increase Rate of Cell with Respect to Number of Cycles

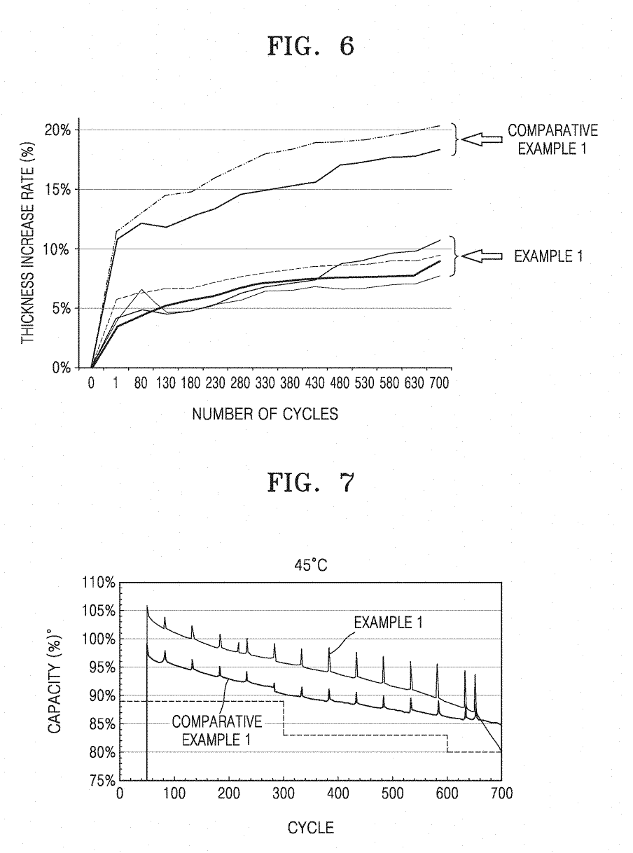

Thickness increase rates of the lithium secondary batteries prepared according to Example 1 and Comparative Example 1 with respect to the number of cycles of charging and discharging were measured and results thereof are shown in FIG. 6. The thickness increase rate is defined as a percentage of a thickness of a battery after charging and discharging (Tₓ) to an initial thickness of the battery (T₁), i.e., [{(Tₓ−T₁)/T₁}×100%].

Referring to FIG. 6, it was confirmed that while an initial thickness increase rate of the lithium secondary battery of Comparative Example 1 was 10% or more and the thickness increase rate steadily increased to 15% or more as the number of cycles of charging and discharging increased, an initial thickness increase rate of the lithium secondary battery of Example 1 was about 5% and the thickness increase rate was maintained at 10% or less even after about 500 cycles of charging and discharging.

### Evaluation Example 4: Evaluation of Lifespan Characteristics of Lithium Secondary Battery

Capacity characteristics of lithium secondary batteries of Example 1 and Comparative Example 1 with respect to the number of cycles of charging and discharging were evaluated and results thereof are shown in FIG. 7.

The capacity characteristics of the batteries were evaluated using a charger/discharger. The batteries were charged at 25° C. with CC-CV of 0.5 C and 4.3 V to a cut-off current of 0.05 C and discharged with a CC of 0.7 C to a cut-off voltage of 3.0 V. Capacities of the batteries were identified at every 50 cycles at a rate of 0.2 C at a cut-off voltage of 3.0 V.

Referring to FIG. 7, it was confirmed that the lithium secondary battery of Example 1 (shown as the upper trace of FIG. 7) had better capacity characteristics with 90% of the capacity maintained until about 600 cycles of charging and discharging and excellent lifespan characteristics in comparison with the lithium secondary battery of Comparative Example 1 (shown as lower trace of FIG. 7).

It should be understood that embodiments described herein should be considered in a descriptive sense only and not for purposes of limitation. Descriptions of features or aspects within each embodiment should typically be considered as available for other similar features or aspects in other embodiments.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, acts, operations, elements, and/or components, but do not preclude the presence or addition of one or more other features, integers, acts, operations, elements, components, and/or groups thereof.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

While one or more embodiments have been described with reference to the figures, it will be understood by those of ordinary skill in the art that various changes in form and details may be made therein without departing from the spirit and scope as defined by the following claims, and equivalents thereof.

What is claimed is:

1. A lithium secondary battery comprising:
a positive electrode;
a negative electrode; and
an electrolyte interposed between the positive electrode and the negative electrode,
wherein a passivation layer is on at least one portion of a surface of the negative electrode after one or more cycles of charging and discharging of the lithium secondary battery, and
wherein the passivation layer comprises a particulate passivation layer and a film-like passivation layer.

2. The lithium secondary battery of claim 1, wherein a thickness of the film-like passivation layer is 10 nm or greater.

3. The lithium secondary battery of claim 1, wherein a ratio D₃₀₀/D₁ of a thickness D₃₀₀ of the film-like passivation layer after 300 cycles of charging and discharging of the lithium secondary battery to a thickness D₁ of the film-like passivation layer after one cycle of charging and discharging of the lithium secondary battery is in a range from about 1.0 to about 1.5.

4. The lithium secondary battery of claim 1, wherein a thickness of the particulate passivation layer is in a range from about 100 nm to about 600 nm.

5. The lithium secondary battery of claim 1, wherein the particulate passivation layer comprises spherical particles having an average diameter in a range of about 50 nm to about 500 nm.

6. The lithium secondary battery of claim 1, wherein a ratio of a thickness of the particulate passivation layer to a thickness of the film-like passivation layer is in a range from about 20:1 to about 3:1.

7. The lithium secondary battery of claim 1, wherein the particulate passivation layer comprises an inorganic compound.

8. The lithium secondary battery of claim 1, wherein the passivation layer is on at least 40% by area of the surface of the negative electrode.

9. The lithium secondary battery of claim 1, wherein the film-like passivation layer is on at least 35% by area of the surface of the negative electrode.

10. The lithium secondary battery of claim 1, wherein a C-rate at which the one cycle of charging and discharging of the lithium secondary battery is performed is in a range from about 0.001 C to about 0.4 C.

11. The lithium secondary battery of claim 1, wherein a temperature at which the one cycle of charging and discharging of the lithium secondary battery is performed is in a range from about 25° C. to about 80° C.

12. The lithium secondary battery of claim 1, wherein the negative electrode comprises:
a negative current collector; and
a negative active material layer on the negative current collector,
wherein the passivation layer is on the negative active material layer.

13. The lithium secondary battery of claim 12, wherein the negative active material layer comprises a carbonaceous negative active material.

14. The lithium secondary battery of claim 1, wherein the electrolyte comprises a lithium salt, a non-aqueous organic solvent, and an additive.

15. The lithium secondary battery of claim 14, wherein the additive comprises vinylene carbonate (VC), vinyl ethylene carbonate (VEC), or fluoroethylene carbonate.
